(19) United States
(12) Patent Application Publication
(10) Pub. No.: US 2024/0349106 A1
(43) Pub. Date: Oct. 17, 2024

(54) METHODS AND APPARATUSES FOR REPORTING IN INTEGRATED ACCESS AND BACKHAUL NETWORK

(71) Applicant: LENOVO (BEIJING) LIMITED, Beijing (CN)

(72) Inventors: Hongmei Liu, Beijing (CN); Zhi Yan, Beijing (CN); Yuantao Zhang, Beijing (CN); Yingying Li, Beijing (CN); Haiming Wang, Beijing (CN)

(21) Appl. No.: 18/681,610

(22) PCT Filed: Aug. 6, 2021
(86) PCT No.: PCT/CN2021/111270

§ 371 Date: Feb. 6, 2024

(51) Int. Cl. H04W 24/10; H04W 84/04

(52) U.S. Cl. CPC H04W 24/10; H04W 84/047

(57) ABSTRACT

Disclosed are methods and apparatuses for multiplexing capability reporting in an integrated access and backhaul (IAB) network. An embodiment of the subject application provides a method performed by an IAB node. The method includes: reporting to a parent node at least one child link parameter associated with a child link of the IAB node, wherein the at least one child link parameter is associated with a time domain duration, and includes at least one of a downlink (DL) transmission (TX) power, a DL Tx timing, a DL Tx spatial domain filter, a DL guard band, a DL guard symbol, an uplink (UL) reception (RX) power, an UL Tx timing, an UL Rx spatial domain filter, a UL guard band, or a UL guard symbol of the child link of the IAB node.

### TECHNICAL FIELD

The present disclosure generally relates to reporting in an integrated access and backhaul (IAB) network, and especially relates to methods and apparatuses for multiplexing capability reporting in an IAB network.

### BACKGROUND OF THE INVENTION

With the ability to support enhanced mobile broadband (eMBB) and ultra-reliable low latency communications (URLLC), the introduction of 5G New Radio (NR) using gigahertz (GHz) spectrum is creating new opportunities for mobile services providers and private enterprises. These high frequencies, however, come with an inherent problem in that the shorter wavelengths have a dramatically smaller signal range and are far more susceptible to interference and degradation. Given that the effective distance of a 5G signal could be as little as 1,000 ft, the current design of 4G radio access networks (where the signal can reach up to 10 miles) must be completely rethought when moving to NR. While the obvious answer is to significantly increase the number of antennas in a given serving area—by as many as 50 per square kilometer, in some cases—this solution is complicated by the need to cheaply and efficiently serve the new base stations with backhaul bandwidth capacity.

IAB leverages the spectral efficiencies of new radio and the increased capacity afforded by the higher bands available in 5G to deliver an alternative to optical cell site backhaul. This alleviates one of the primary issues surrounding the deployment of 5G that can be employed as a short-term alternative to fiber or as a permanent option for more isolated antennas or those without right of way access.

IAB allows for multi-hop backhauling using the same frequencies employed for user equipment (UE) access or a distinct, dedicated, frequency. The IAB Mobile Termination (MT) antenna is either an independent set of arrays (IAB-MT) or they share the same antennas used for access and are referred to as virtual IAB-MTs (vIAB-MT). Shared frequency and combined radio unit implementations are naturally recognized as being more efficient than the decoupled alternatives. Integrated Access and Backhaul specifications define two antenna system types: An IAB node and an IAB donor. IAB donors terminate the backhaul traffic from distributed IAB nodes. These nodes can be backhaul endpoints or relays between those endpoints and the donor. Both IAB donors and nodes serve mobile UEs in the usual way.

### SUMMARY

Embodiments of the present disclosure provide solutions related to multiplexing capability reporting in an IAB network for adaption of an IAB node's multiplexing operation. In particular, the solutions are related to what parameters are to be reported, how to report these parameters, and when to report these parameters.

According to some embodiments of the present disclosure, a method performed by an IAB node is provided. The method includes: reporting to a parent node at least one child link parameter associated with a child link of the IAB node, wherein the at least one child link parameter is associated with a time domain duration, and includes at least one of a downlink (DL) transmission (Tx) power, a DL Tx timing, a DL Tx spatial domain filter, a DL guard band, a DL guard symbol, an uplink (UL) reception (Rx) power, an UL Tx timing, an UL Rx spatial domain filter, a UL guard band, or a UL guard symbol of the child link of the IAB node, and the IAB node is in one case of: time division multiplexing (TDM) multiplexing mode being adopted between a parent link of the IAB node and the child link of the IAB node; UL transmission at the parent link of the IAB node being performed simultaneously with UL transmission or DL transmission at the child link of the IAB node; UL transmission at a child link of a child node of the IAB node being performed simultaneously with UL transmissions or DL transmission at the child link of the IAB node; DL reception at the parent link of the IAB node being performed simultaneously with UL transmission or DL transmission at the child link of the IAB node; or DL reception at the child link of the child node of the IAB node being performed simultaneously with UL transmission or DL transmission at the child link of the IAB node.

In some embodiments, in the time domain duration, the at least one child link parameter has a single value, multiple values, or at least one range of value.

In some embodiments, in response to that the at least one child link parameter has multiple values, the time domain duration is divided into multiple parts, and each of the multiple parts is associated with one of the multiple values.

In some embodiments, the at least one child link parameter is reported via at least one of a physical uplink control channel (PUCCH), a physical uplink shared channel (PUSCH), or a medium access control (MAC) control element (CE).

In some embodiments, in response to that the at least one child link parameter is reported via the PUCCH or the PUSCH, a priority for the reporting is determined based on at least one of a reporting metric, a distributed unit (DU) cell index, and a child link index.

In some embodiments, an time offset between reporting the at least one child link parameter and starting of the associated time domain duration is predefined, reported from the IAB node to the parent node of the IAB node, or configured by the parent node of the IAB node; and in response to that the time offset is reported, the time offset is reported together with or separated from the at least one child link parameter.

In some embodiments, a value of the DL Tx power, the DL Tx timing, the UL Rx power, or the UL Tx timing is an absolute value, or a differential value with respect to a basic value.

In some embodiments, the basic value for the DL transmission power is a value of the DL transmission power when TDM mode is adopted between the parent link of the IAB node and the child link of the IAB node, and the basic value for the UL reception power is a value of the UL reception power when the node is in the TDM mode between its parent link and child link.

In some embodiments, the DL Tx spatial domain filter or UL Rx spatial domain filter indicates at least one reference signal (RS) of synchronization signal block (SSB), channel quality indication reference signal (CSI-RS), positioning reference signal (PRS), and sounding reference signal (SRS).

In some embodiments, the at least one RS associated with the DL or UL spatial domain filter is a recommended RS, a not preferred RS or combination thereof.

In some embodiments, the DL guard band or the UL guard band indicates whether non-used DL physical resource blocks (PRBs) or non-used UL PRBs of the child link are at an upper boundary or at a lower boundary of a child link bandwidth.

In some embodiments, the DL guard symbol indicates whether a number of DL guard symbols of the child link are at beginning or ending of a child link transmission duration, and the UL guard symbol indicates whether a number of UL guard symbols of the child link are at beginning or ending of a child link reception duration.

In some embodiments, a sub-carrier space (SCS) for determining a unit of any one of the DL guard band, the UL guard band, the DL guard symbol, and the UL guard symbol is configured, or is determined according to at least one of a PUSCH SCS, a PUCCH SCS, a SSB SCS, and a PRACH SCS of the child link.

In some embodiments, the reporting is per child link or per pair of DU cell and mobile terminal (MT) cloud computing (CC).

In some embodiments, the reporting of the at least one child link parameter is triggered by the parent node via a download control information (DCI).

In some embodiments, the reporting of the at least one child link parameter is initiated by the IAB node via transmitting a physical random access channel (PRACH) to the parent node.

In some embodiments, separate random access occasions (ROs) or preambles are used for transmitting the PRACH to indicate purpose of the reporting.

In some embodiments, in case that there are a first child link parameter and a second child link parameter for a same time duration reported and the first and second child link parameters are contradicting with each other, a latest one of the first and second child link parameters has a higher priority.

According to some embodiments of the present disclosure, a method performed by an IAB node is provided. The method includes: receiving from a child IAB node at least one child link parameter associated with a child link of the child IAB node, wherein the at least one child link parameter is associated with a time domain duration, and includes at least one of a downlink (DL) transmission (TX) power, a DL Tx timing, a DL Tx spatial domain filter, a DL guard band, a DL guard symbol, an uplink (UL) reception (RX) power, an UL Tx timing, an UL Rx spatial domain filter, a UL guard band, or a UL guard symbol of the child link of the child IAB node, and the child IAB node is in one case of: time division multiplexing (TDM) multiplexing mode being adopted between a parent link of the child IAB node and the child link of the child IAB node; UL transmission at the parent link of the child IAB node being performed simultaneously with UL transmission or DL transmission at the child link of the child IAB node; UL transmission at a child link of a child node of the child IAB node being performed simultaneously with UL transmissions or DL transmission at the child link of the child IAB node; DL reception at the parent link of the child IAB node being performed simultaneously with UL transmission or DL transmission at the child link of the child IAB node; or DL reception at the child link of the child node of the child IAB node being performed simultaneously with UL transmission or DL transmission at the child link of the child IAB node.

In some embodiments, in the time domain duration, the at least one child link parameter has a single value, multiple values, or at least one range of value.

In some embodiments, in response to that the at least one child link parameter has multiple values, the time domain duration is divided into multiple parts, and each of the multiple parts is associated with one of the multiple values.

In some embodiments, the at least one child link parameter is received via at least one of a physical uplink control channel (PUCCH), a physical uplink shared channel (PUSCH), or a medium access control (MAC) control element (CE).

In some embodiments, in response to that the at least one child link parameter is received via the PUCCH or the PUSCH, a priority for the reception is determined based on at least one of a reception metric, a distributed unit (DU) cell index, and a child link index.

In some embodiments, an time offset between receiving the at least one child link parameter and starting of the associated time domain duration is predefined, received from the child IAB node, or configured by the IAB node; and in response to that the time offset is received, the time offset is received together with or separated from the at least one child link parameter.

In some embodiments, a value of the DL Tx power, the DL Tx timing, the UL Rx power, or the UL Tx timing is an absolute value, or a differential value with respect to a basic value.

In some embodiments, the basic value for the DL transmission power is a value of the DL transmission power when TDM mode is adopted between the parent link of the child IAB node and the child link of the child IAB node, and the basic value for the UL reception power is a value of the UL reception power when the child IAB node is in the TDM mode between its parent link and child link.

In some embodiments, the DL Tx spatial domain filter or UL Rx spatial domain filter indicates at least one reference signal (RS) of synchronization signal block (SSB), channel quality indication reference signal (CSI-RS), positioning reference signal (PRS), and sounding reference signal (SRS).

In some embodiments, the at least one RS associated with the DL or UL spatial domain filter is a recommended RS, a not preferred RS or combination thereof.

In some embodiments, the DL guard band or the UL guard band indicates whether non-used DL physical resource blocks (PRBs) or non-used UL PRBs of the child link are at an upper boundary or at a lower boundary of a child link bandwidth.

In some embodiments, the DL guard symbol indicates whether a number of DL guard symbols of the child link are at beginning or ending of a child link transmission duration, and the UL guard symbol indicates whether a number of UL guard symbols of the child link are at beginning or ending of a child link reception duration.

In some embodiments, a sub-carrier space (SCS) for determining a unit of any one of the DL guard band, the UL guard band, the DL guard symbol, and the UL guard symbol is configured, or is determined according to at least one of a PUSCH SCS, a PUCCH SCS, a SSB SCS, and a PRACH SCS of the child link.

In some embodiments, the reception is per child link or per pair of DU cell and mobile terminal (MT) cloud computing (CC).

In some embodiments, the reception of the at least one child link parameter is triggered by the IAB node transmitting a download control information (DCI) to the child IAB node.

In some embodiments, the reception of the at least one child link parameter is initiated by the child IAB node transmitting a physical random access channel (PRACH) to the IAB node.

In some embodiments, separate random access occasions (ROs) or preambles are used for receiving the PRACH.

In some embodiments, in case that there are a first child link parameter and a second child link parameter for a same time duration received and the first and second child link parameters are contradicting with each other, a latest one of the first and second child link parameters has a higher priority.

According to some embodiments of the present disclosure, an apparatus includes: at least one non-transitory computer-readable medium having computer-executable instructions stored thereon, at least one receiving circuitry, at least one transmitting circuitry, and at least one processor coupled to the at least one non-transitory computer-readable medium, the at least one receiving circuitry and the at least one transmitting circuitry. The computer-executable instructions, when executed by the at least one processor, cause the at least one processor to implement various methods according to any embodiments of the present disclosure.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates a schematic diagram of an exemplary wireless communication scenario according to some embodiments of the present disclosure;

FIG. 2 illustrates some cases for an IAB node.

FIG. 3 illustrates a flow chart of an exemplary method performed by an IAB node according to some embodiments of the present disclosure;

FIG. 4 illustrates a DL Tx power value and DL Tx spatial domain filer of a child link;

FIG. 5 illustrates a UL Rx power value and UL Rx spatial domain filter of a child link;

FIG. 6 illustrates a DL Tx timing value of a child link;

FIG. 7 illustrates a UL Tx timing value of a child link;

FIG. 8 illustrates a signaling flow chart for reporting at least one child link parameter according to some embodiments of the present disclosure;

FIG. 9 illustrates an exemplary preconfigured reporting pattern;

FIG. 10 illustrates a flow chart of an exemplary method performed by an IAB node according to some embodiments of the present disclosure;

FIG. 11 illustrates a simplified block diagram of an exemplary apparatus according to some other embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Embodiments of the present disclosure provide solutions related to multiplexing capability reporting in an IAB network for adaption of an IAB node's multiplexing operation: what parameters are reports, how to perform the reporting, and when to perform the reporting.

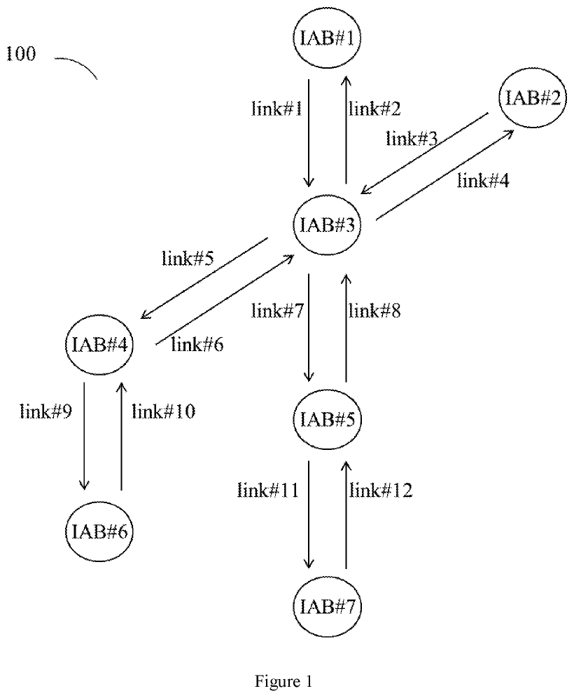

FIG. 1 illustrates a schematic diagram of an exemplary wireless communication system 100 according to some embodiments of the present disclosure.

It is appreciated that wireless communication system 100 is an IAB network which includes 7 IAB nodes. In some embodiments, there may be more IAB nodes included in system 100, and the systems of the present disclosure are not limited to system 100 shown in FIG. 1.

Furthermore, it is appreciated that the IAB nodes shown in FIG. 1 may be any apparatus that may perform IAB functions and any other functions.

The wireless communication system (e.g., system 100) of the present disclosure is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, a long term evolution (LTE) network, a 3GPP-based network, a 3GPP 5G network, a satellite communications network, a high-altitude platform network, and/or other communications networks.

More generally, the wireless communication system 100 may implement some other open or proprietary communication protocols, for example, World Interoperability for Microwave Access (WiMAX), among other protocols.

As shown in FIG. 1, there are at least seven IAB nodes (IAB #1˜IAB #7) in system 100, herein IAB #1 and IAB #2 are IAB #3's parent nodes, IAB #5 and IAB #4 are IAB #3's child nodes, IAB #6 is IAB #4's child node, IAB #7 is IAB #5's child node; in other words, IAB #3 is a child node of IAB #1 and IAB #2, IAB #3 is a parent node of IAB #4 and IAB #5, IAB #4 is IAB #6's parent node, IAB #5 is IAB #7's parent node.

According to the present disclosure, each IAB node in a system may have at least one child link and/or at least one parent link. There may be UL transmission and DL transmission at each link. For simplification, hereinafter UL transmission at a link is referred as a UL sub link, and DL transmission at a link is referred as a DL sub link. In other words, a link between two IAB nodes includes a DL sub link and a UL sub link.

For example, the link between IAB #1 and IAB #3 includes DL sub link #1 and UL sub link #2, the link between IAB #4 and IAB #6 includes DL sub link #9 and UL sub link #10.

The system 100 is a cascade system, an IAB node may have at least one parent IAB node and may have at least one child IAB node. For example, IAB #1 is a parent IAB node of IAB #3, and IAB #7 is a child IAB node of IAB #5.

A link between an IAB node and its parent IAB node is referred as the IAB node's parent link, herein the parent link may have a DL parent sub link and a UL parent sub link.

A link between an IAB node and its child IAB node is referred as the IAB node's child link, herein the child link may have a child DL sub link and a child UL sub link.

For example, as shown in FIG. 1, link #1, link #2, link #3, and link #4 are parent sub links of IAB #3, and link #5, link #6, link #7, and link #8 are child sub links of IAB #3, wherein link #1, link #3, link #5, and link #7 are DL sub links, and link #2, link #4, link #6, and link #8 are UL sub links.

According to the present disclosure, an IAB node may work in multiplexing case 1, and it means that TDM multiplexing mode is used between a parent link of the IAB node and a child link of the IAB node; for example, IAB #3 works in multiplexing case 1 means that TDM multiplexing mode is used between one parent link (including e.g., sub link #2 and sub link #1) of IAB #3 and one child link (including e.g., sub link #7 and sub link #7) of IAB #3, i.e. the time domain resources used by parent link and child link are different.

According to the present disclosure, an IAB node may work in multiplexing case 2, and it means that UL transmission at a parent link of the IAB node is performed simultaneously with UL transmission or DL transmission at a child link of the IAB node; for example, IAB #3 works in multiplexing case 2 means that UL transmission at sub link #2 of IAB #3 is performed simultaneously with UL transmission at sub link #8 of IAB #3 or with DL transmission at sub link #7 of IAB #3.

According to the present disclosure, an IAB node may work in multiplexing case 3, and it means that UL transmission at a child link of a child node of the IAB node is performed simultaneously with UL transmissions or DL transmission at a child link of the IAB node; for example, IAB #3 works in multiplexing case 3 means that UL transmission at sub link #12 is performed simultaneously with UL transmissions at sub link #8 of IAB #3 or with DL transmission at sub link #7 of IAB #3, and sub link #12 is IAB #5's child link, and IAB #5 is IAB #3's child link.

According to the present disclosure, an IAB node may work in multiplexing case 4, and it means that DL reception at a parent link of the IAB node is performed simultaneously with UL transmission or DL transmission at a child link of the IAB node; for example, IAB #3 works in multiplexing case 4 means that DL reception at sub link #1 of IAB #3 is performed simultaneously with UL transmission at sub link #8 or with DL transmission at sub link #7 of IAB #3.

According to the present disclosure, an IAB node may work in multiplexing case 5, and it means that DL reception at a child link of a child node of the IAB node is performed simultaneously with UL transmission or DL transmission at a child link of the IAB node; for example, IAB #3 works in multiplexing case 5 means that DL reception at child sub link #11 is performed simultaneously with UL transmission at sub link #8 or DL transmission at sub link #7 of IAB #3, and sub link #11 is IAB #5's child link, and IAB #5 is IAB #3's child node.

The term “simultaneously” used hereinafter means that two transmissions are performed using same time domain resources, and may use different frequency domain or spatial domain resources. The two transmission may be performed at the exactly same time or there is relatively short time period (e.g. a fraction of a symbol or several symbols,) between the two transmissions.

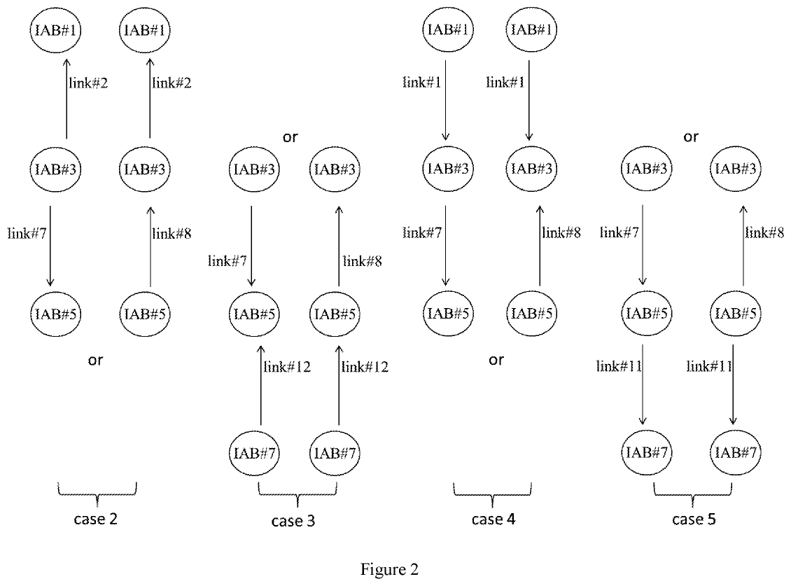

FIG. 2 in combination with FIG. 1 illustrates some examples of IAB #3 working in multiplexing cases 2-5.

As shown in FIG. 2, each of multiplexing case 2-5 has two sub cases.

For IAB #3 works in multiplexing case 2, one sub case is that sub link #2 and sub link #7 are performed simultaneously; another sub case is that sub link #2 and sub link #8 are performed simultaneously.

For IAB #3 works in multiplexing case 3, one sub case is that sub link #7 and sub link #12 are performed simultaneously; another sub case is that sub link #8 and sub link #12 are performed simultaneously.

For IAB #3 works in multiplexing case 4, one sub case is that sub link #1 and sub link #7 are performed simultaneously; another sub case is that sub link #1 and sub link #8 are performed simultaneously.

For IAB #3 works in multiplexing case 5, one sub case is that sub link #7 and sub link #11 are performed simultaneously; another sub case is that sub link #8 and sub link #11 are performed simultaneously.

According to the present disclosure, an IAB node reports to a parent node per (sub)child link or per pair of (DU cell, MT CC) on information about at least one of power, timing, beam (or spatial domain filter), guard band, guard symbol of a child sub DL link and/or a child UL sub link of the IAB node. The power, timing, beam (or spatial domain filter), guard band, guard symbol of the IAB node are different for different cases where the IAB node works.

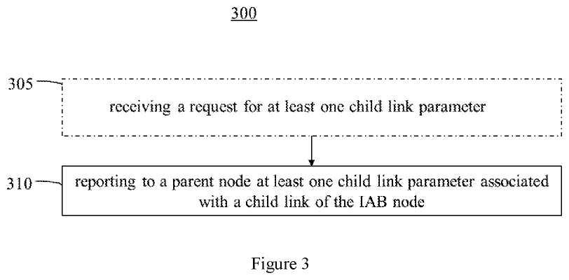

FIG. 3 illustrates a flow chart of an exemplary method 300 performed by an IAB node (e.g., IAB #3 in FIG. 1, or an apparatus having IAB function) according to some embodiments of the present disclosure. It should be understood that method 300 can also be performed by other apparatus(es) having similar functionality.

As shown in FIG. 3, method 300 includes at least operation 310, wherein operation 310 illustrates that an IAB node reports to a parent node of the IAB node, at least one child link parameter associated with a child link (a UL child link or a DL child link) of the IAB node, wherein the at least one child link parameter is associated with a time domain duration, and the at least one child link parameter includes at least one a DL Tx power, a DL Tx timing, a DL Tx spatial domain filer, a DL guard band, a DL guard symbol, an UL Rx power, an UL Tx timing, an UL Rx spatial domain filter, a UL guard band, or a UL guard symbol of the child link (a UL sub child link and/or a DL sub child link) of the IAB node; and wherein the IAB node works in one case of case 1-case 5 as mentioned previously.

For example, IAB #3 reports at least one child link parameter of sub link #7 to parent node IAB #1, herein IAB #3 works in case 2, UL transmission at parent sub link #2 of IAB node IAB #3 is performed simultaneously with DL transmission at child sub link #7 of the IAB node.

For example, IAB #3 repots at least one child link parameter of sub link #8 to parent IAB node IAB #1, herein IAB #3 works in case 3, UL transmission at child sub link #12 of child node IAB #5 of IAB node IAB #3 is performed simultaneously with UL transmission at child sub link #8 of IAB #3.

For example, IAB #5 reports at least one child link parameter of sub link #12 to parent node IAB #3, herein IAB #5 works in case 1, TDM multiplexing mode is adopted between parent sub links (link #8 and link #7) of IAB #5 and child sub links (link #12 and link #11) of IAB #5.

In some embodiments, the IAB node reports to the parent node of the IAB node per child link or per pair of DU cell and MT CC.

In some embodiments, in the associated time domain duration, the at least one child link parameter has a single value, multiple values, or at least one range of value.

In some embodiments, if the at least one child link parameter has multiple values, the time domain duration is divided into multiple parts, and each of the multiple parts is associated with one of the multiple values.

In some embodiments, when an IAB node works in different cases, the value of a DL Tx power, a DL Tx timing, a DL Tx spatial domain filer, a DL guard band, a DL guard symbol, a UL Rx power, a UL Tx timing, an UL Rx spatial domain filter, a UL guard band, or a UL guard symbol of a child link of the IAB node may be different.

In some embodiments, an IAB node itself may initiate step 310, i.e., reporting of at least one child link parameter to the parent node. In some embodiments, method 300 may further include operation 305, i.e., receiving a request for at least one child link parameter from the parent IAB node. That is, the reporting may be triggered by the parent IAB node with a request for the child link parameter(s) of the IAB node.

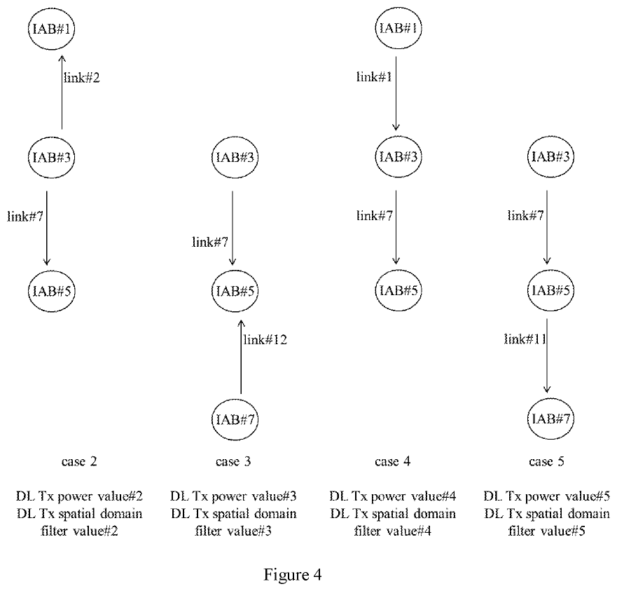

Regarding a DL Tx power of a child link (or a child DL sub link) of an IAB mode, there may be five kinds of values corresponding to five cases, wherein FIG. 4 illustrates DL Tx power of child DL sub link #7 when IAB #3 is in cases 2-5 respectively.

When TDM multiplex mode is adopted between a parent link of IAB #3 and a child link of IAB #3, i.e., IAB #3 works in case 1, the DL Tx power of child DL sub link #7 has a value of DL Tx power value #1 (not shown in FIG. 4).

When UL transmission at parent UL sub link #2 of IAB #3 is performed simultaneously with DL transmission at child DL sub link #7 of IAB #3, i.e., IAB #3 works in case 2, the DL Tx power of child DL sub link #7 has a value of DL Tx power value #2.

When UL transmission at child UL sub link #12 of child IAB #5 of IAB #3 is performed simultaneously with DL transmission at child DL sub link #7 of IAB #3, i.e., IAB #3 works in case 3, the DL Tx power of child DL sub link #7 has a value of DL Tx power value #3.

When UL transmission at parent DL sub link #1 of IAB #3 is performed simultaneously with DL transmission at child DL sub link #7 of IAB #3, i.e., IAB #3 works in case 4, the DL Tx power of child DL sub link #7 has a value of DL Tx power value #4.

When DL transmission at child DL sub link #11 of child IAB #5 of IAB #3 is performed simultaneously with DL transmission at child DL sub link #7 of IAB #3, i.e., IAB #3 works in case 5, the DL Tx power of child DL sub link #7 has a value of DL Tx power value #5.

In some embodiments, the 5 values of the DL Tx power of a child link are updated semi-statically, i.e., the 5 values may be provided to the IAB node (via e.g., a signaling) in advance.

In some embodiments, when reporting the DL Tx power of the child link to the parent IAB node, the IAB node only need to indicate which of the 5 values is reported, i.e., reporting selection among the 5 values of the DL Tx power of the child link is dynamically.

In some embodiments, there are also five kinds of values (DL Tx spatial domain filter value #1-DL Tx spatial domain filter value #5) of the DL Tx spatial domain filter corresponding to different multiplexing cases. FIG. 4 illustrates the DL Tx spatial domain filter of child DL sub link #7 when IAB #3 is in cases 2-5 respectively.

In some embodiments, the DL Tx spatial domain filter indicates at least one RS of SSB, CSI-RS, PRS, and SRS. In some embodiments, the at least one RS is a recommended RS, a not preferred RS, or combination thereof.

In some embodiments, the 5 values of the DL Tx spatial domain filter of a child link are updated semi-statically, i.e., the 5 values may be provided to the IAB node (via e.g., a signaling) in advance.

In some embodiments, when reporting the DL Tx spatial domain filter of the child link to the parent IAB node, the IAB node only need to indicate which of the 5 values is reported, i.e., reporting selection among the 5 values of the DL Tx spatial domain filter of the child link is dynamically.

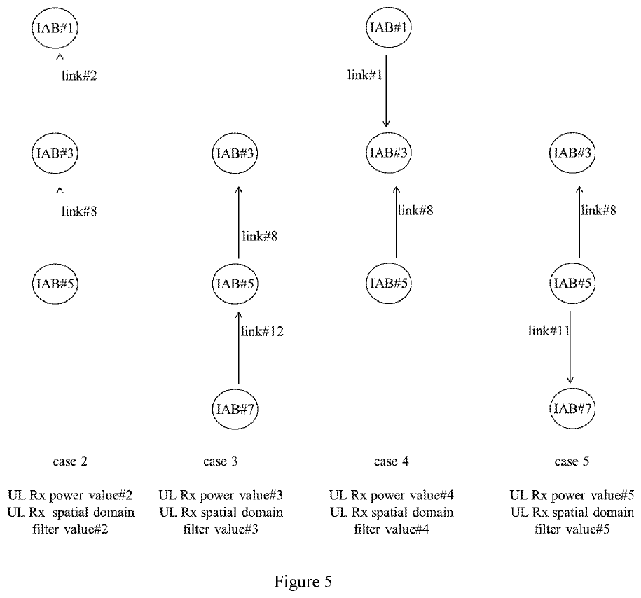

Regarding a UL Rx power of a child link (or a child UL sub link) of an IAB mode, there may be five kinds of values corresponding to five cases, wherein FIG. 5 illustrates the UL Rx power of child UL sub link #8 when IAB #3 is in cases 2-5 respectively.

When TDM multiplex mode is adopted between a parent link of IAB #3 and a child link of IAB #3, i.e., IAB #3 works in case 1, the UL Rx power of a child UL sub link #8 has a value of UL Rx power value #1 (not shown in FIG. 5).

When UL transmission at parent UL sub link #2 of IAB #3 is performed simultaneously with UL transmission at child UL sub link #8 of IAB #3, i.e., IAB #3 works in case 2, the UL Rx power of child DL sub link #8 has a value of UL Rx power value #2.

When UL transmission at child UL sub link #12 of child IAB #5 of IAB #3 is performed simultaneously with DL transmission at child UL sub link #8 of IAB #3, i.e., IAB #3 works in case 3, the UL Rx power of child UL sub link #8 has a value of UL Rx power value #3.

When DL transmission at parent DL sub link #1 of IAB #3 is performed simultaneously with UL transmission at child DL sub link #8 of IAB #3, i.e., IAB #3 works in case 4, the UL Rx power of child DL sub link #8 has a value of UL Rx power value #4.

When DL transmission at child DL sub link #11 of child IAB #5 of IAB #3 is performed simultaneously with UL transmission at child UL sub link #8 of IAB #3, i.e., IAB #3 works in case 5, the UL Rx power of child UL sub link #8 has a value of UL power Rx value #5.

In some embodiments, there are also five values of the UL Rx spatial domain filter (UL Rx spatial domain filter value #1-UL Rx spatial domain filter value #5) corresponding to different multiplexing cases. FIG. 5 illustrates the UL Rx spatial domain filter of child DL sub link #8 when IAB #3 is in cases 2-5 respectively

In some embodiments, the UL Rx power or the DL Tx power may be an absolute value.

In some embodiments, the UL Rx power or the DL Tx power in cases 2-5 may be a differential value to a basic value. In some embodiments, the basic value for the UL Rx power is a value of the DL Tx power parameter when the IAB node is in multiplexing case 1, and the basic value for the UL reception power parameter is a value of the UL Rx power parameter when the IAB node is in multiplexing case 1.

In some embodiments, the 5 values of the UL Rx power of a child link are updated semi-statically, i.e., the 5 values may be provided to the IAB node (via e.g., a signaling) in advance.

In some embodiments, when reporting the UL Rx power of the child link to the parent IAB node, the IAB node only need to indicate which of the 5 values is reported, i.e., reporting selection among the 5 values of the UL Rx power of the child link is dynamically.

In some embodiments, there are also five kinds of values of the UL Rx spatial domain filter corresponding to different multiplexing cases. FIG. 5 illustrates the UL Rx spatial domain filter of child UL sub link #8 when IAB #3 is in cases 2-5 respectively.

In some embodiments, the UL Rx spatial domain filter indicates at least one RS of SSB, CSI-RS, PRS, and SRS. In some embodiments, the at least one RS is a recommended RS, a not preferred RS, or combination thereof.

In some embodiments, the 5 values of the UL Rx spatial domain filter of a child link are updated semi-statically, i.e., the 5 values may be provided to the IAB node (via e.g., a signaling) in advance.

In some embodiments, when reporting the UL Rx spatial domain filter of the child link to the parent IAB node, the IAB node only need to indicate which of the 5 values is reported, i.e., reporting selection among the 5 values of the UL Rx spatial domain filter of the child link is dynamically.

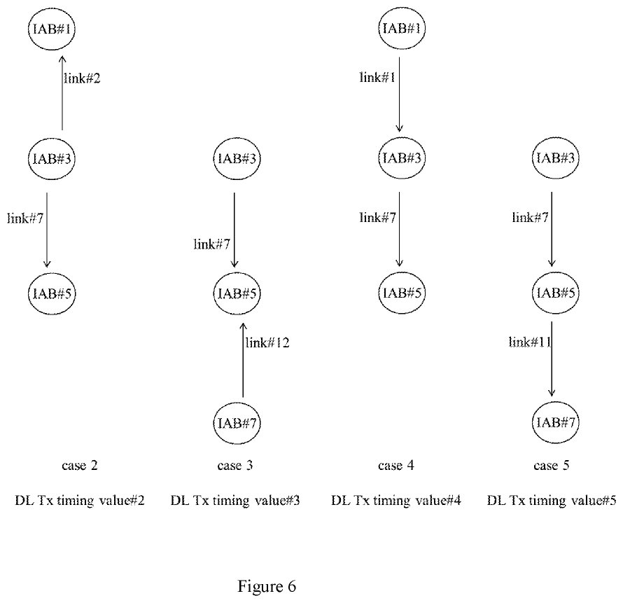

Regarding a DL Tx timing of a child link (or a child DL sub link) of an IAB mode, there may be three kind of values corresponding to five cases, wherein FIG. 6 illustrates the DL Tx timing of child DL sub link #7 when IAB #3 is in cases 2-5 respectively.

When IAB #3 works in case 1, the DL Tx power of child DL sub link #7 has a value of DL Tx timing value #1 (not shown in FIG. 6).

When UL transmission at parent UL sub link #2 of IAB #3 is performed simultaneously with DL transmission at child DL sub link #7 of IAB #3, i.e., IAB #3 works in case 2, the DL Tx timing of child DL sub link #7 has a value of DL Tx timing value #1.

When UL transmission at child UL sub link #12 of child IAB #5 of IAB #3 is performed simultaneously with DL transmission at child DL sub link #7 of IAB #3, i.e., IAB #3 works in case 3, the DL Tx timing of child DL sub link #7 has a value of DL Tx timing value #1.

When UL transmission at parent DL sub link #1 of IAB #3 is performed simultaneously with DL transmission at child DL sub link #7 of IAB #3, i.e., IAB #3 works in case 4, the DL Tx timing of child DL sub link #7 has a value of DL Tx timing value #2.

When DL transmission at child DL sub link #11 of child IAB #5 of IAB #3 is performed simultaneously with DL transmission at child DL sub link #7 of IAB #3, i.e., IAB #3 works in case 5, the DL Tx timing of child DL sub link #7 has a value of DL Tx timing value #3.

In some embodiments, the DL Tx timing may be an absolute value or a differential value to a basic value. In some embodiments, the basic value for DL Tx timing is a value of the DL Tx timing when the IAB node is in multiplexing case 1.

In some embodiments, the 3 values of the DL Tx timing of a child link are updated semi-statically, i.e., the 3 values may be provided to the IAB node (via e.g., a signaling) in advance.

In some embodiments, when reporting the DL Tx timing of the child link to the parent IAB node, the IAB node only need to indicate which of the 5 values is reported, i.e., reporting selection among the 3 values of the DL Tx timing of the child link is dynamically.

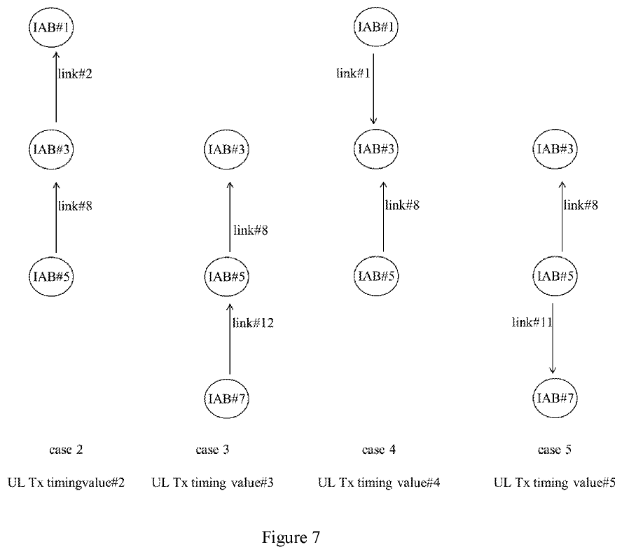

Regarding a UL Tx timing of a child link (or a child DL sub link) of an IAB mode, there may be five kind of values corresponding to five cases, wherein FIG. 7 illustrates the UL Tx timing of child UL sub link #7 when IAB #3 is in cases 2-5 respectively.

When IAB #3 works in case 1, the UL Tx timing of child DL sub link #7 has a value of UL Tx timing value #1 (not shown in FIG. 7).

When UL transmission parent UL sub link #2 of IAB #3 is performed simultaneously with DL transmission at child UL sub link #8 of IAB #3, i.e., IAB #3 works in case 2, the UL Tx timing of child UL sub link #8 has a value of UL Tx timing value #2.

When UL transmission at child UL sub link #12 of child IAB #5 of IAB #3 is performed simultaneously with UL transmission at child UL sub link #8 of IAB #3, i.e., IAB #3 works in case 3, the UL Tx timing of child UL sub link #8 has a value of UL Tx timing value #3.

When UL transmission at parent DL sub link #1 of IAB #3 is performed simultaneously with UL transmission at child UL sub link #8 of IAB #3, i.e., IAB #3 works in case 4, the UL Tx timing of child UL sub link #8 has a value of UL Tx timing value #4.

When UL transmission at child DL sub link #11 of child IAB #5 of IAB #3 is performed simultaneously with UL transmission at child UL sub link #8 of IAB #3, i.e., IAB #3 works in case 5, the UL Tx timing of child UL sub link #8 has a value of UL Tx timing value #5.

In some embodiments, UL Tx timing value #3 is same as UL Tx timing value #5. For example, if reception timing on UL sub link #12 is the same as transmission timing on DL sub link #11, then UL Tx timing value #3 is the same as UL Tx timing value #5.

In some embodiments, the UL Tx timing may be an absolute value or a differential value to a basic value. In some embodiments, the basic value for UL Tx timing is a value of the UL Tx timing when the IAB node is in multiplexing case 1.

In some embodiments, the 5 values of the UL T timing of a child link are updated semi-statically, i.e., the 5 values may be provided to the IAB node (via e.g., a signaling) in advance.

In some embodiments, when reporting the UL Tx timing of the child link to the parent IAB node, the IAB node only need to indicate which of the 5 values is reported, i.e., reporting selection among the 5 values of the UL Tx timing of the child link is dynamically.

The DL guard band indicates whether a number of non-used DL PRBs are in upper boundary or lower boundary of a child link bandwidth.

The UL guard band indicates whether a number of non-used UL PRBs are in upper boundary or lower boundary of a child link bandwidth.

The DL guard symbol indicates whether a number of DL guard symbols are at beginning or ending of the whole child link transmission duration.

The UL guard symbol indicates whether a number of UL guard symbols are at beginning or ending of the whole child link reception duration.

In some embodiments, an SCS for determining a unit of any one of the DL guard band, the UL guard band, the DL guard symbol, and the UL guard symbol is predefined, configured, or is determined according to at least one of a PUSCH SCS, a PUCCH SCS, a SSB SCS, and a PRACH SCS of the child link.

In some embodiments, the SCS may be determined based on frequency band of the child link.

The description above indicates what to be reported by an IAB node to a parent IAB node of the IAB node.

In some embodiments according to the present disclosure, the at least one child link parameter is reported via at least one of a PUCCH, a PUSCH, or a MAC CE.

In some embodiments according to the present disclosure, if the at least one child link parameter is reported via a PUCCH or a PUSCH, a priority for the reporting need to be determined based on at least one of a reporting metric, a DU cell index, and a child link index. E.g. when the priority is determined based on the reporting metric, the reporting with power may have higher priority than the reporting with guard band.

In some embodiments, in case that there are multiple child link parameters for a same time duration are to be reported and the multiple child link parameters are contradicting with each other, a latest one of the multiple child link parameters has a higher priority. E.g. If there is a reporting in time instance #0 for time instance #5 indicating that the UL Tx timing is value #1, and there is another reporting in time instance #3 for time instance #5 indicating that UL Tx timing is value #3, then the UL Tx timing in time instance #5 reported by the IAB node to its parent node is UL Tx timing value #3.

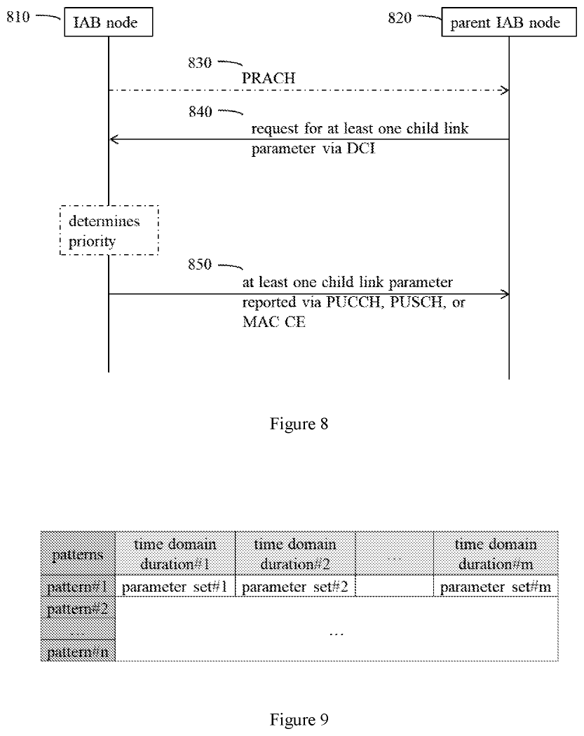

FIG. 8 illustrates a signaling flow chart for reporting at least one child link parameter according to some embodiments of the present disclosure;

In some embodiments, IAB node 810 itself may initiate reporting of at least one child link parameter of a child link of IAB 810. In some embodiments, IAB node 810 may transmit a PRACH 830 to parent IAB node 820, indicating that there is potential reporting of at least one child link parameter of a child link associated with a time domain duration. In some embodiments, PARCH 830 is transmitted via separate random access occasions (ROs) or preambles. In this case, at least one RO or preamble can be reserved, and which RO or preamble is reserved can be predefined or preconfigured by SIB or RRC signaling. With reception of a PRACH associated with the reserved RO or preamble from an IAB node, the IAB node's parent node can conclude that there is a request for child link parameter reporting. Then the parent node can perform corresponding scheduling based on the request. In some embodiments, after receiving PRACH 830 from the IAB node, parent IAB node 820 may triggers the report of the at least one child link parameter of the child link via a DCI.

In some embodiments, even without PRACH 830 transmitted from IAB node 810, parent node 820 of IAB node 810 itself may send a request to triggering IAB node 810 to transmit at least one child link parameter of a child link of IAB node 810 via a DCI. There may be separate bits in the DCI for indicating the trigger of the reporting, or a DCI with a separate RNTI can be used to trigger the reporting

After reception of request 840, if the at least one child link parameter is to be reported via PUCCH or PUSCH, IAB node 810 may determine the priority of the at least one child link parameter based on at least one of a reporting metric, a DU cell index, and a child link index. Furthermore, if there are multiple child link parameters for a same time duration to be reported and the multiple child link parameters are contradicting with each other, a latest one of the multiple child link parameters has a higher priority.

At last, IAB node 810 transmits at least one child link parameter 850 to parent IAB node 820.

In FIG. 8, as aforementioned, the operation for determining priority of the at least one child link parameter is not necessarily required to be performed, it depends on specific conditions of the at least one child link parameter or etc.; furthermore, PRACH 830 is not necessarily required to be transmitted, it depends on specific system configurations or etc.

In some embodiments, there is an offset between reporting the at least one child link parameter by an IAB node and starting of the associated time domain duration, the offset is predefined or configured by a parent IAB node of the IAB node. The offset can be several slots or symbols. The SCS of the offset can be same as the SCS of the time domain duration.

In some embodiments, the IAB node reporting at least one child link parameter of its child link to a parent IAB node also reports the offset.

In some embodiments, the offset is reported together with or separated from the at least one child link parameter.

According to the present disclosure, a child link parameter reported is associated with a time domain duration. A reporting pattern may be used for reporting at least one child link parameter associated with at least one time domain duration.

In some embodiments, the reporting pattern may be preconfigured by RRC or MAC CE.

In some embodiments, multiple report patterns may be preconfigured.

FIG. 9 illustrates an exemplary preconfigured reporting pattern, herein m and n are positive integers.

As shown in FIG. 9, referring to reporting pattern #1 as an example, each parameter set of parameter set #1-parameter set #m includes at least one child link parameter, and each of the parameter set may include the same or different child link parameters. E.g. parameter set #m may include DL Tx timing value #1, DL Tx power value #1, UL Tx timing value #1, guard band value #2, guard symbol value #3. Furthermore, in each time domain instance of time domain duration #1, the child link parameter(s) reported by the IAB node are the same, and for different time domain durations, the child link parameter(s) reported by the IAB node can be different.

As shown in FIG. 9, the IAB node is preconfigured with n reporting patterns. Dynamic signaling may further select one of the n reporting patterns.

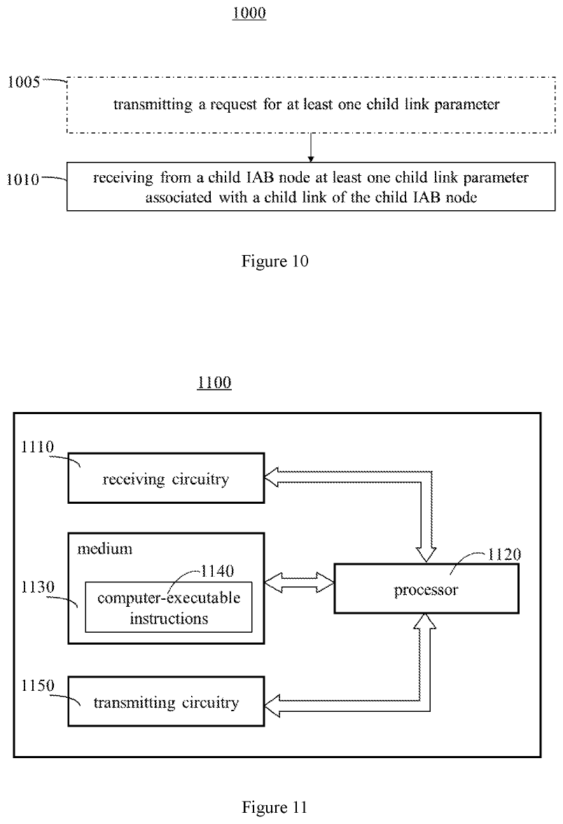

FIG. 10 illustrates a flow chart of an exemplary method 1000 performed by a parent IAB node (e.g., parent IAB #1 in FIG. 1, or an apparatus having parent IAB function) according to some embodiments of the present disclosure. It should be understood that method 300 can also be performed by other apparatus(es) having similar functionality. Method 1000 corresponds to method 300, wherein method 300 is performed by a child IAB node (e.g., IAB #3) and method 1000 is performed by a parent IAB node (e.g., IAB #1)

As shown in FIG. 10, method 1000 includes at least operation 1010, wherein operation 1010 illustrates that an IAB node receives from a child IAB node at least one child link parameter associated with a child link (a UL child link or a DL child link) of the child IAB node of the IAB node, wherein the at least one child link parameter is associated with a time domain duration, and the at least one child link parameter includes at least one a DL Tx power, a DL Tx timing, a DL Tx spatial domain filer, a DL guard band, a DL guard symbol, an UL Rx power, an UL Tx timing, an UL Rx spatial domain filter, a UL guard band, or a UL guard symbol of the child link (a UL sub child link and/or a DL sub child link) of the child IAB node; and wherein the child IAB node works in one case of case 1-case 5 as mentioned previously.

In some embodiments, method 1000 may further include operation 1005, i.e., transmitting a request for at least one child link parameter of a child IAB node. That is, the reporting from a child IAB node may be triggered by a parent IAB node of the child IAB node with a request for the child link parameter(s) of the child IAB node.

According to the present disclosure, various solutions, methods, and embodiments are provided to determine what kinds of child link parameters are reported, when to report the child link parameters, and how to report the child link parameters.

The present disclosure is not limited to the various provided methods, embodiments, and signaling sequences, and these methods, embodiments, and signaling sequences may be reasonably and flexibly adjusted or changed.

FIG. 11 illustrates a simplified block diagram of an exemplary apparatus 1100 according to some embodiments of the present disclosure. The apparatus 1100 may be an child IAB node (e.g, IAB #3) or may perform at least functions of a child IAB node, furthermore, the apparatus 1100 may be a parent IAB node (e.g., IAB #1) or may perform at least functions of a parent IAB node. The apparatus 1100 may perform method 300 (acting as a child IAB) or method 1000 (acting as a parent IAB).

As shown in FIG. 11, the apparatus 1100 may include at least one receiving circuitry 1110, at least one processor 1120, at least one non-transitory computer-readable medium 1130 with computer-executable program code 1140 or instructions stored thereon, and at least one transmitting circuitry 1150. The at least one receiving circuitry 1110, the at least one non-transitory computer-readable medium 1130, and at least one transmitting circuitry 1150 may be coupled to the at least one processor 1120. In some embodiments, the at least one receiving circuitry 1110, the at least one non-transitory computer-readable medium 1130, at least one transmitting circuitry 1150, and the at least one processor 1120 may be coupled to each other via one or more local buses.

Although in FIG. 11, elements such as at least one receiving circuitry 1110, at least one transmitting circuitry 1150, at least one non-transitory computer-readable medium 1130, and at least one processor 1120 are described in the singular, the plural is contemplated unless limitation to the singular is explicitly stated. In some embodiments of the present disclosure, the at least one receiving circuitry 1110 and the at least one transmitting circuitry 1150 may be configured for wireless communication. In some embodiments of the present disclosure, the at least one receiving circuitry 1110 and at least one transmitting circuitry 1150 can be integrated into at least one transceiver (e.g., wireless transceiver). In certain embodiments of the present disclosure, the apparatus 1100 may further include a memory and/or other components.

Computer-executable program code 1140 or instructions may be configured to be executable by the at least one processor 1120 to cause the apparatus 1100 at least to perform, with the at least one receiving circuitry 1110, at least one transmitting circuitry 1050, and the at least one processor 1120, any one of the various methods described above which are performed by a UE according to the present disclosure. For example, computer-executable program code 1140 or instructions, when executed by the at least one processor 1120, may cause the apparatus 1100 to report to a parent node at least one child link parameter associated with a child link of the IAB node, wherein the at least one child link parameter is associated with a time domain duration, and includes at least one of a DL Tx power, a DL Tx timing, a DL Tx spatial domain filter, a DL guard band, a DL guard symbol, an UL RX power, an UL Tx timing, an UL Rx spatial domain filter, a UL guard band, or a UL guard symbol of the child link of the IAB node, and the IAB node is in one case of: TDM multiplexing mode being adopted between a parent link of the IAB node and the child link of the IAB node; UL transmission at the parent link of the IAB node being performed simultaneously with UL transmission or DL transmission at the child link of the IAB node; UL transmission at a child link of a child node of the IAB node being performed simultaneously with UL transmissions or DL transmission at the child link of the IAB node; DL reception at the parent link of the IAB node being performed simultaneously with UL transmission or DL transmission at the child link of the IAB node; or DL reception at the child link of the child node of the IAB node being performed simultaneously with UL transmission or DL transmission at the child link of the IAB node.

In various example embodiments, at least one processor 1120 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, at least one processor 1120 may also include at least one other circuitry or element not shown in FIG. 11.

In various example embodiments, at least one non-transitory computer-readable medium 1130 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, at least one non-transitory computer-readable medium 1130 may include, but is not limited to, an electric, a magnetic, an optical, an electromagnetic, an infrared, or a semiconductor system, apparatus, or device or any combination of the above.

Further, in various example embodiments, the example apparatus 1100 may also include at least one other circuitry, element, and interface, for example antenna element, and the like.

In various example embodiments, the circuitries, parts, elements, and interfaces in the example apparatus 1100, including at least one processor 1120 and at least one non-transitory computer-readable medium 1130, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A method performed by an integrated access and backhaul (IAB) node, the method comprising:
reporting to a parent node at least one child link parameter associated with a child link of the IAB node,
wherein the at least one child link parameter is associated with a time domain duration, and includes at least one of a downlink (DL) transmission (TX) power, a DL Tx timing, a DL Tx spatial domain filter, a DL guard band, a DL guard symbol, an uplink (UL) reception (RX) power, an UL Tx timing, an UL Rx spatial domain filter, a UL guard band, or a UL guard symbol of the child link of the IAB node, and the IAB node is in one case of:
time division multiplexing (TDM) multiplexing mode being adopted between a parent link of the IAB node and the child link of the IAB node;
UL transmission at the parent link of the IAB node being performed simultaneously with UL transmission or DL transmission at the child link of the IAB node;
UL transmission at a child link of a child node of the IAB node being performed simultaneously with UL transmissions or DL transmission at the child link of the IAB node;
DL reception at the parent link of the IAB node being performed simultaneously with UL transmission or DL transmission at the child link of the IAB node; or
DL reception at the child link of the child node of the IAB node being performed simultaneously with UL transmission or DL transmission at the child link of the IAB node.

2. The method of claim 1, wherein in the time domain duration, the at least one child link parameter has a single value, multiple values, or at least one range of value.

3. The method of claim 2, wherein in response to that the at least one child link parameter has multiple values, the time domain duration is divided into multiple parts, and each of the multiple parts is associated with one of the multiple values.

4. The method of claim 1, wherein the at least one child link parameter is reported via at least one of a physical uplink control channel (PUCCH), a physical uplink shared channel (PUSCH), or a medium access control (MAC) control element (CE).

5. The method of claim 4, in response to that the at least one child link parameter is reported via the PUCCH or the PUSCH, a priority for the reporting is determined based on at least one of a reporting metric, a distributed unit (DU) cell index, and a child link index.

6. The method of claim 1, wherein:
a time offset between reporting the at least one child link parameter and starting of the associated time domain duration is predefined, reported from the IAB node to the parent node of the IAB node, or configured by the parent node of the IAB node; and
in response to that the time offset is reported, the time offset is reported together with or separated from the at least one child link parameter.

7. The method of claim 1, wherein the DL Tx spatial domain filter or UL Rx spatial domain filter indicates at least one reference signal (RS) of synchronization signal block (SSB), channel quality indication reference signal (CSI-RS), positioning reference signal (PRS), and sounding reference signal (SRS).

8. The method of claim 7, wherein the at least one RS associated with the DL or UL spatial domain filter is a recommended RS, a not preferred RS or combination thereof.

9. The method of claim 1, wherein the DL guard band or the UL guard band indicates whether non-used DL physical resource blocks (PRBs) or non-used UL PRBs of the child link are at an upper boundary or at a lower boundary of a child link bandwidth.

10. The method of claim 1, wherein the DL guard symbol indicates whether a number of DL guard symbols of the child link are at beginning or ending of a child link transmission duration, and the UL guard symbol indicates whether a number of UL guard symbols of the child link are at beginning or ending of a child link reception duration.

11. The method of claim 1, wherein the reporting is per child link or per pair of DU cell and mobile terminal (MT) cloud computing (CC).

12. The method of claim 1, wherein the reporting of the at least one child link parameter is triggered by the parent node via a download control information (DCI).

13. The method of claim 1, wherein the reporting of the at least one child link parameter is initiated by the IAB node via transmitting a physical random access channel (PRACH) to the parent node.

14. The method of claim 1, in case that there are a first child link parameter and a second child link parameter for a same time duration reported and the first and second child link parameters are contradicting with each other, a latest one of the first and second child link parameters has a higher priority.

15. (canceled)

16. An integrated access and backhaul (IAB) node, comprising:
at least one memory; and
at least one processor coupled with the at least one memory and configured to cause the IAB node to:
report to a parent node at least one child link parameter associated with a child link of the IAB node,
wherein the at least one child link parameter is associated with a time domain duration, and includes at least one of a downlink (DL) transmission (TX) power, a DL Tx timing, a DL Tx spatial domain filter, a DL guard band, a DL guard symbol, an uplink (UL) reception (RX) power, an UL Tx timing, an UL Rx spatial domain filter, a UL guard band, or a UL guard symbol of the child link of the IAB node, and the IAB node is in one case of:
time division multiplexing (TDM) multiplexing mode being adopted between a parent link of the IAB node and the child link of the IAB node;
UL transmission at the parent link of the IAB node being performed simultaneously with UL transmission or DL transmission at the child link of the IAB node;
UL transmission at a child link of a child node of the IAB node being performed simultaneously with UL transmissions or DL transmission at the child link of the IAB node;
DL reception at the parent link of the IAB node being performed simultaneously with UL transmission or DL transmission at the child link of the IAB node; or
DL reception at the child link of the child node of the IAB node being performed simultaneously with UL transmission or DL transmission at the child link of the IAB node.

17. The IAB node of claim 16, wherein in the time domain duration, the at least one child link parameter has a single value, multiple values, or at least one range of value.

18. The IAB node of claim 17, wherein in response to that the at least one child link parameter has multiple values, the time domain duration is divided into multiple parts, and each of the multiple parts is associated with one of the multiple values.

19. The IAB node of claim 16, wherein the at least one child link parameter is reported via at least one of a physical uplink control channel (PUCCH), a physical uplink shared channel (PUSCH), or a medium access control (MAC) control element (CE).

20. The IAB node of claim 19, in response to that the at least one child link parameter is reported via the PUCCH or the PUSCH, a priority for the reporting is determined based on at least one of a reporting metric, a distributed unit (DU) cell index, and a child link index.

21. A processor of an integrated access and backhaul (IAB) node for wireless communication, comprising:
at least one controller coupled with at least one memory and configured to cause the processor to:
report to a parent node at least one child link parameter associated with a child link of the IAB node,
wherein the at least one child link parameter is associated with a time domain duration, and includes at least one of a downlink (DL) transmission (TX) power, a DL Tx timing, a DL Tx spatial domain filter, a DL guard band, a DL guard symbol, an uplink (UL) reception (RX) power, an UL Tx timing, an UL Rx spatial domain filter, a UL guard band, or a UL guard symbol of the child link of the IAB node, and the IAB node is in one case of:
time division multiplexing (TDM) multiplexing mode being adopted between a parent link of the IAB node and the child link of the IAB node;
UL transmission at the parent link of the IAB node being performed simultaneously with UL transmission or DL transmission at the child link of the IAB node;
UL transmission at a child link of a child node of the IAB node being performed simultaneously with UL transmissions or DL transmission at the child link of the IAB node;
DL reception at the parent link of the IAB node being performed simultaneously with UL transmission or DL transmission at the child link of the IAB node; or
DL reception at the child link of the child node of the IAB node being performed simultaneously with UL transmission or DL transmission at the child link of the IAB node.
